(19) United States
(12) Patent Application Publication
(10) Pub. No.: US 2014/0079942 A1
(43) Pub. Date: Mar. 20, 2014

(54) FIRE-RETARDANT COATING, METHOD FOR PRODUCING FIRE-RETARDANT AND HEAT-RESISTNAT BUILDING MATERIALS

(71) Applicant: Thomas Jospeh Lally, Oak Brook, IL (US)

(72) Inventor: Thomas Jospeh Lally, Oak Brook, IL (US)

(21) Appl. No.: 13/573,487

(22) Filed: Sep. 18, 2012

(51) Int. Cl. C09K 21/04; B32B 9/00; B32B 13/04; B32B 21/04; B32B 29/06; B32B 19/04; B32B 3/26; B32B 15/04

(52) U.S. Cl. 428/319.1; 252/601; 428/408; 428/471; 428/537.1; 428/537.7; 428/697

(57) ABSTRACT

The present invention relates to a fire-retardant material and products produced therefrom. More specifically, one embodiment of the present invention relates to a fire-retardant coating that shields underlying substrates from thermal insult, and a method for making such fire-retardant composition, as well as the products resulting therefrom. The invented coating and products are especially applicable to cellulose and gypsum based building materials including but not limited to fiberboards, wallboards, roofing materials, particleboards, ceiling tiles, floor tiles, soundproofing boards and hardboards.

### RELATION TO OTHER APPLICATIONS

The present application is a Continuation-In-Part of, and seeks priority to, U.S. patent application Ser. No. 12/286,259, which is a Continuation-In-Part of, and seeks priority to, U.S. patent application Ser. No. 11/156,395 filed Jun. 20, 2005 now U.S. Pat. No. 7,429,290, which is a Continuation-In-Part of, and seeks priority to U.S. patent application Ser. No. 10/818,268, which is a Continuation-In-Part of, and seeks priority to U.S. patent application Ser. No. 10/338,425 filed Jan. 8, 2003 now U.S. Pat. No. 6,787,495, which is a divisional of U.S. patent application Ser. No. 09/602,067, filed Jun. 22, 2000, now U.S. Pat. No. 6,533,821, all of which are hereby incorporated by reference in their entireties.

### FIELD OF INVENTION

The present invention relates to a fire-retardant material. More specifically, the present invention relates to a fire-retardant coating that shields underlying substrates from thermal insult. The invented coating is especially applicable to cellulose-based building materials including but not limited to fiberboards, wallboards, roofing materials, particleboards, ceiling tiles, flooring tiles, soundproofing boards and hardboards. This novel composition is also useful in providing a fire-resistant coating for concrete, metals, foamed polymeric materials, gypsum and other building substrates.

### BACKGROUND OF THE INVENTION

Gypsum based and cellulose-based products (made from cellulosic fibers, chips and shavings) make up a significant portion of the building product market because they are cost effective and easy to work with. Cellulose-based products provide structural support, act as roofing substrates, and even dampen unwanted noise. Unfortunately, untreated cellulose-based products are particularly susceptible to flame and thermal damage because they are composed of flammable fibers or particles. A number of coatings have been developed to reduce the flammability of such materials, but too often these methods are inadequate at providing fire-retardancy, are too expensive, produce toxic-off gas or smoke under continued exposure to flame, or have some other shortcoming.

A need exists for fire-retardant coating for building materials that is cost effective, non toxic and which provides superior fire-retardancy.

### SUMMARY OF THE INVENTION

One or more embodiments of the present invention provide a ceramic-based film which can be use to impart thermal and structural integrity to an underlying substrate. A feature of the film is it ability to impart structural rigidity to the substrate while also increasing heat and flame resistance.

Another embodiment of the invention relates to products comprised of a substrate coating with the fire-retardant composition.

In one or more embodiment the present invention is mixed with a cellulosic and/or gypsum material.

Another aspect of one or more embodiments the invention is the ability to impregnate and/or coat the substrate to which it is applied.

### DETAILED DESCRIPTION OF THE INVENTION

The invented refractory coating and the method for producing the coating confers enhanced flame and heat resistance to building materials. Exemplary materials include steel, various ferrous and non-ferrous metals, woods, gypsums, composites of wood and cellulose, concrete, mortars, and synthetic products, including plastics, paper and carbon composites. The present invention is especially suited for coating cellulose or cellulose based building materials like fiberboards, particleboards, gypsum based products, and medium density fiberboard (MDF).

The refractory composition generally comprises the following: a metal oxide, a mono-potassium phosphate, magnesium oxide, a calcium phosphate and water. One preferred formulation of the fire-retardant coating includes the following: Formulation I

| | |
|---|---|
| KH₂PO₄ (“MKP”) | 45 weight percent of the dry mixture |
| MgO | 45 weight percent of the dry mixture |
| Tricalcium phosphate | 10 weight percent of the dry mixture[\ |

Water is added at 30 weight percent of the dry mixture.

Water is added at 30 weight percent of the dry mixture.

In a preferred embodiment the MKP, MgO, and the tri-calcium phosphate are mixed together in powder form to create a homogeneous dry mixture. Obtaining a homogenous dry mixture can be accomplished through a number of techniques well known in the art including ribbon mixing. See, U.S. patent application Ser. No. 09/602,067, now U.S. Pat. No. 6,533,821 filed by instant inventor on Jun. 22, 2200, and incorporated herein by reference in its entirety.

The dry mixture is mixed with water to form a slurry. In Formulation I, water is added at 30 weight percent of the dry mixture, however, water can be added at between 15 and 55 weight percent of the dry mixture. A suitable temperature range for the water is between 40-90° F. The temperature of the water is directly related to the mixture's reactivity, thus the rate of the reaction can be controlled to some degree by the temperature of the water being added. Hotter water tends to speed up the reaction while cool water tends to slow it down. It should be noted that the temperature of all other reagents in the present invention were at approximately room temperature (˜68° F.), although reagents having different temperatures can be used. The temperature of the reagents, like that of water, affects the reactivity of the slurry. Hotter reagents tend to speed up the reaction while cool reagents tend to slow it down.

The slurry is mixed until a homogeneous slurry is obtained. Suitable mixing times for most applications are between 30 seconds and 10 minutes. Mixing can be achieved using several techniques well known in the art including but not limited to mixing by hand and using an electronic hand mixer. The slurry is produced at the user site. Alternatively, the dry mixture and water can be mixed using various spray technologies where the water and dry mixture are mixed prior to, or after release from the spraying apparatus. Other mixing techniques and composition preparations can also be envisioned.

While the above-mentioned formulation and weight percents are the most preferred proportions, a range of the constituents can also used. The following weight percents are based on the weight of the combined dry mixture. For example, between approximately 20-50 weight percent mono potassium phosphate (“MKP”) can be utilized. The MgO can be utilized in a weight percent between 10-40 percent. Between approximately 20-50 weight percent silica powder can be utilized, while the silicate is suitably present in a weight percent between approximately 1-50 weight percent. The weight ratio of the MKP to MgO should be between 1:1 and 3:1, preferably at a weight ratio of approximately 2:1.

Dry Mixture Components

One salient feature of the present invention is a metal oxide. MgO is the preferred metal oxide, however, other metal oxides may be used including but not limited to: alkali metal and alkali earth metal oxides, iron oxide, aluminum oxide, zinc oxide and combinations thereof. Preferably the MgO is light burned and is a powder having a particle size of between 30-200 microns.

Another salient feature of the present composition is a phosphate compound, preferably mono potassium phosphate (“MKP”). Other phosphates including: alkali or alkali earth metal phosphates, mono-ammonium phosphate, diammonium phosphate, phosphoric acid, aluminum phosphate, and combinations thereof can also be used. Preferably the MKP is a tech grade powder or granule with a particle size between 30-100 microns.

Various charring agents (i.e. starch) can be added to the present invention to provide additional fire protection. The charring agents form another layer of protection when exposed to flame. Such charring agents are especially important if the composition is being used to make a intumescent paint or coating.

Application of Fire-Retardant Slurry

The compositions of the present invention can be applied to building substrates by any technique well known in the art including but not limited to: spraying, rolling, brushing, dripping, painting, trolling, and dip coating. The techniques will vary according to desired results. When applied to cellulose based (or other fibrous) materials the composition impregnates and/or forms a coating on the substrate. Impregnation will increase if the slurry is applied to the substrate while it is still in a semi-wet or doughy state.

The setting time of the slurry will depend on a number of factors including reagent and water temperatures and slurry thickness. The slurry will generally cure faster with increased thickness. High temperature reagents will tend to speed up the slurry reaction and cause it to cure at an increased rate. Curing will result in a hardened, fire-resistant coating upon the substrate.

Having described the basic concept of the invention, it will be apparent to those skilled in the art that the foregoing detailed disclosure is intended to be presented by way of example only, and is not limiting. Various alterations, improvements, and modifications are intended to be suggested and are within the scope and spirit of the present invention. Additionally, the recited order of the elements or sequences, or the use of numbers, letters or other designations therefore, is not intended to limit the claimed processes to any order except as may be specified in the claims. Accordingly, the invention is limited only by the following claims and equivalents thereto.

All publications and patent documents cited in this application are incorporated by reference in their entirety for all purposes to the same extent as if each individual publication or patent document were so individually denoted.

I claim the following:

1. A fire-retardant building product comprising:
a substrate coated with a fire-retardant composition, wherein the fire-retardant composition comprises: a mono-potassium phosphate, magnesium oxide, a calcium phosphate, and water, and wherein the weight percent ratio of the phosphate to metal oxide is between about 1:1 and 3:1.

2. The product of claim 1, wherein phosphate to metal oxide is approximately 2:1.

3. The product of claim 1, wherein the coating impregnates the substrate.

4. The product of claim 1, wherein the calcium containing compound is tri-calcium phosphate.

5. A fire-retardant described in claim 1, wherein the substrate is selected from the group consisting of: steel, ferrous metals, non-ferrous metals, woods, gypsums, wood composites, concrete, mortars, synthetics products, paper, carbon composites, foamed polymeric materials and combinations thereof.
